(19) United States
(12) Patent Application Publication
(10) Pub. No.: US 2009/0034246 A1
(43) Pub. Date: Feb. 5, 2009

(54) Flashlight Assembly from Oil Type Lighters

(76) Inventor: John Alfred Ayres, Lapeer, MI (US)

Correspondence Address: Nu-Tech and Engineering Inc., 186 Briarwood Drive, Lapeer, MI, 48446, US

(21) Appl. No.: 12/180,532

(22) Filed: Jul. 26, 2008

Related U.S. Application Data
(60) Provisional application No. 60/962,466, filed on Jul. 30, 2007.

(51) Int. Cl. F21L 4/00; F21L 4/04

(52) U.S. Cl. 362/200; 362/208

(57) ABSTRACT

Oil-type cigarette lighters are converted to small flashlights by utilizing the lighter insert sub-assembly to house a LED module and a battery module. These modules are connected together by an insulated wire passing through the wick hole of the insert sub-assembly and a switch that contacts the hinge side of the lighter outer case lid.

This patent application claims the benefit of a prior-filed provisional patent application having Ser. No. 60/962,466 filed on Jul. 30, 2007.

### BACKGROUND ART

1. Field of the Invention

This invention relates to lamps, flashlights, and signal lights and particularly to a flashlight assembly made by converting the insert sub-assembly of an oil-type cigarette lighter to a battery powered flashlight sub-assembly which is then inserted into the oil-type lighter outer case.

2. Description of the Related Art

Lighter Assemblies for Use in a Flashlight Shell (Outer Case) are shown in Zippo U.S. Pat. Nos. 5,359,505 and 5,424,929. In both patents, a flashlight is created by replacing the oil-type cigarette lighter insert sub-assembly by a new battery powered lighting module. The insert sub-assembly is not used as part of the flashlight as it is in this invention. The advantage of this invention over the prior art is its simplicity and low conversion cost.

### SUMMARY OF THE INVENTION

It is therefore an object of the present invention to utilize the insert sub-assembly of an oil-type cigarette lighter to provide a lighting sub-assembly for insertion into a cigarette lighter outer case.

It is a further object of the present invention to provide one or more light sources within the oil-type lighter insert sub-assembly.

It is a still further object of the present invention to provide light source control within the oil-type lighter insert sub-assembly.

It is a still further object of the present invention to provide light switching means at the hinge side of the cigarette lighter outer case.

It is a still further object of the present invention to utilize the oil-type lighter insert as a conduction path for an electrical circuit.

It is a still further object of the present invention to utilize a spark from an oil-type lighter insert sub-assembly to activate the light source.

Toward the fulfillment of these and other objects, this invention includes LED (light emitting diodes) and Battery modules to convert oil-type lighters to small flashlights. These modules utilize the direct contact of a battery terminal to the inside lighter insert to complete the electrical circuit. One or more LED's are used as the light source providing long battery life and high brightness. These flashlights utilize both the standard size oil lighter (such as the zippo brand) as well as the smaller lighter sizes. This provides a bright compact pocket or purse light source for general nighttime lighting for traveling or camping as well as a compact emergency light source for home or business use. These flashlights are very compact and thin. They have smooth covered outside surfaces making them ideal to carry. They are attractive and the cases can be decorated to suit the owner. Existing lighters can easily be retrofitted with the battery and LED modules to convert an existing lighter to a flashlight. In addition, new flashlights can be manufactured utilizing many of the existing components used in oil-type lighters, making it easy to go into production with this type of flashlight. The components required to convert the lighters to flashlights are readily available and are low cost. Batteries can be easily changed as required. These flashlights are activated by movement of the lighter lid or by a separate manually operated switch or by a spark from the lighter ignition components.

### BRIEF DESCRIPTION OF THE DRAWINGS

Advantages of the invention will be readily appreciated as the same becomes better understood by reference to the following detailed description when considered in connection with the accompanying drawings, wherein:

FIG. 1 is an overview of typical sub-assembles used in this invention.

FIG. 2 is a top oblique view of a flashlight sub-assembly utilizing a preferred embodiment of this invention.

FIG. 3 is a side view of the preferred embodiment shown in FIG. 2.

FIG. 4 is a side view of an LED sub-assembly used in the preferred embodiment.

FIG. 5 is a side view of an alternate LED sub-assembly with electronic drive circuit.

FIG. 6 is an oblique top view showing the LED sub-assembly of FIG. 4 being assembled into an oil-type lighter insert.

FIG. 7 is an oblique view of a flashlight assembly with a 2^{nd} preferred embodiment.

FIG. 8 is an electrical circuit schematic for a duel LED sub-assembly.

### DESCRIPTION OF THE PREFERRED EMBODIMENT

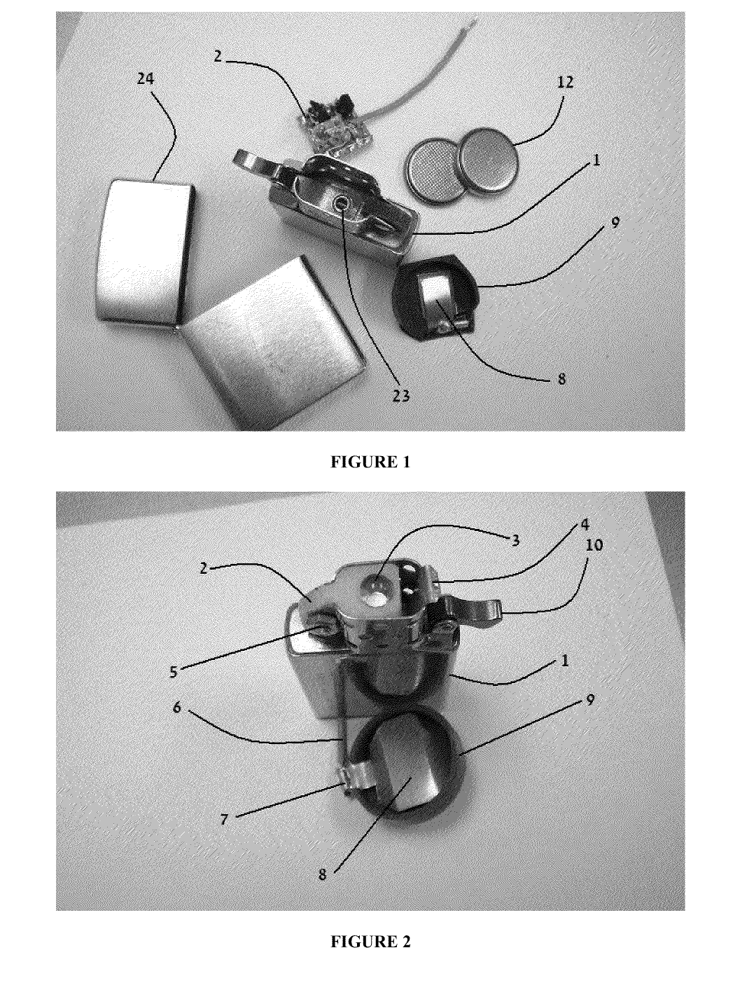

FIG. 1 is an overview of the elements used to convert an oil-type cigarette lighter to a flashlight according to this invention. The insert sub-assembly 1 becomes a basic flashlight by the addition of the battery housing 9 with a spring electrical contact 8, batteries 12, and lamp module 2 connected to battery housing 9 through wick hole 23. The converted oil-type lighter sub-assembly 1 is then inserted back into the original outer case 24 to complete the flashlight assembly.

FIG. 2 shows a preferred embodiment of a flashlight sub-assembly consisting of insert sub-assembly 1 that has been converted from a oil-type cigarette lighter insert. A lamp module 2 containing LED 3 is secured in insert sub-assembly 1 by screw 5. The attachment hole for screw 5 is the original hole used to mount the cigarette lighter flint striker wheel (which has been removed). The lamp module 2 is made from an electrically insulating material and provides support to an electrical contact switch 4 which makes contact with the body of the insert sub-assembly 1 to close an electrical circuit and light LED 3. Cam 10 is the original cigarette lighter lid closure cam. When the insert sub-assembly 1 is placed into an original outer case of the cigarette lighter 24 of FIG. 1, then closure of the lid of the outer case 24 bears against the electrical switch 4 pushing it away from a surface of the insert sub-assembly 1 and opening the circuit to LED 3. This action turns off the LED 3 when the cigarette lighter lid is closed. Electrical contact switch 4 must be insulated at its tip where it contacts the lighter lid (not shown) to prevent shorting back to insert sub-assembly 1 when the lighter lid is closed. An insulated wire 6 is attached to battery contact 8 at junction 7. Battery contact 8 is made from an electrical spring material such as beryllium copper. The battery contact 8 is contained inside battery housing 9 which is made from an electrically insulating material. The insulated wire 6 passes from the bottom of the insert sub-assembly 1 through the wick hole 13 shown in FIG. 1. It then electrically connects with one pin of LED 3 (connection not shown).

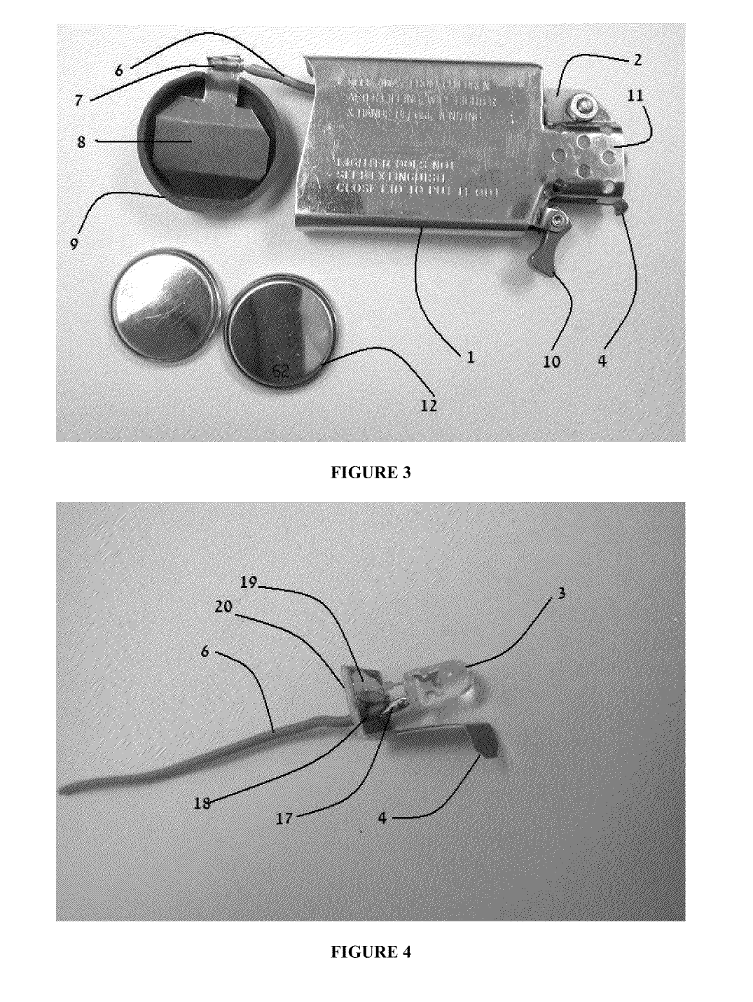

FIG. 3 is a side view insert sub-assembly 1. Numbers correspond in all Figures. Lamp module 2 is shown mounted inside the wind guard 11 of the insert sub-assembly 1. Batteries 12 (i.e., CR-2032) are placed in series in battery holder 9. The battery holder 9 with the battery contact 8 and the batteries 12 is then pushed to the right in FIG. 3 inside the empty shell of the insert sub-assembly 1. Electrical contact to the pins of LED 3 is then made through insulated wire 6 and a contact between one battery terminal and the inside metal surface of insert sub-assembly 1, provided that electrical switch 4 is in contact with the surface of the wind guard 11 which is part of the insert sub-assembly 1.

FIG. 4 shows how the LED 3, the electrical contact switch 4, and insulated wire 6 are joined together. One pin 17 of LED 1 is soldered to insulated wire 6 after passing through a hole 18 in the bent electrical contact switch 4. This pin does not make electrical contact with the electrical contact switch 4. The other pin of LED 3 is soldered to the surface of electrical contact switch 4 at location 19. A layer of electrical insulation 20 is attached to the bottom of electrical contact switch 4 to prevent electrical contact of the electrical contact switch 4 with the insert sub-assembly 1 when it is installed into insert sub-assembly 1. Therefore, one electrical contact to the LED 3 is made through the insulated wire 6 and the other electrical contact to the LED 3 is made through the electrical contact switch 4. Battery orientation in the battery holder 9 depends on which LED 3 contact is soldered to the electrical contact switch 4. If the cathode of LED 3 is soldered to electrical contact switch 4, then the batteries should be installed in the battery holder 9 with the positive terminal facing battery contact 8. FIG. 8 is an electrical schematic showing how two LED's in place of LED 3 could be connected for installation in sub-assembly 1. Two switches are provided. SW1 is user selected and would be incorporated as part of lamp module 2 (shown in FIG. 2). SW2 (such as electrical contact switch 4) is actuated by the opening and closing of the cigarette lighter lid. Both LED1 and LED2 could be two white LED's or any other colors. Also, LED1 could function as a narrow beam flashlight, while LED2 cold function as a lantern by using a diffused lens rather than a focused lens. Additionally, one LED cold be a warning light of a different color than the flashlight. The battery and wiring would be the same as described above in the case of the single LED 3.

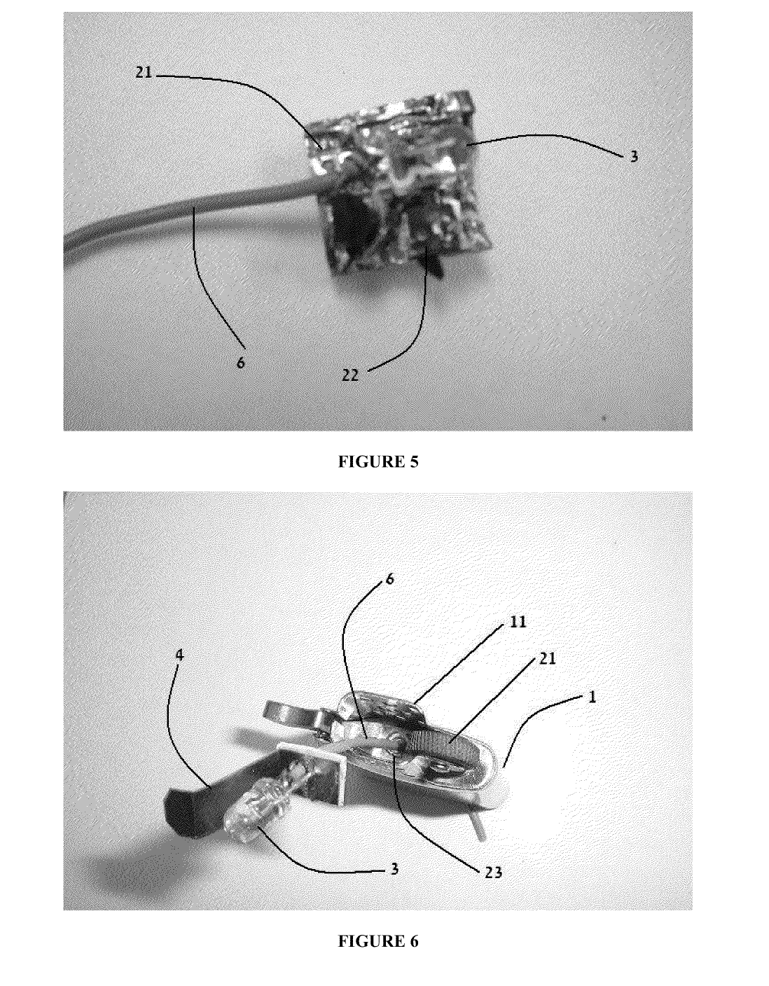

FIG. 5 shows LED 3 mounted on a circuit board assembly 21, various electrical control functions cold be provided. For example, switch 22 could replace the electrical contact switch 4. It would still be actuated by the hinge side of the cigarette lighter lid. Transistors could be mounted on the circuit board to control the LED 3 by sensing the switch 22. The transistors could also be activated by a phototransistor or diode in response to a spark from the cigarette lighter spark wheel.

FIG. 6 shows the installation of the assembly shown in FIG. 4 into the insert sub-assembly 1. Insert sub-assembly 1 in this case still has the spark wheel 21. Insulated wire 6 is shown passing through the wick hole 23. The LED 3 and electrical contact switch 4 subassembly is held in place inside the wind guard 11 by an adhesive.

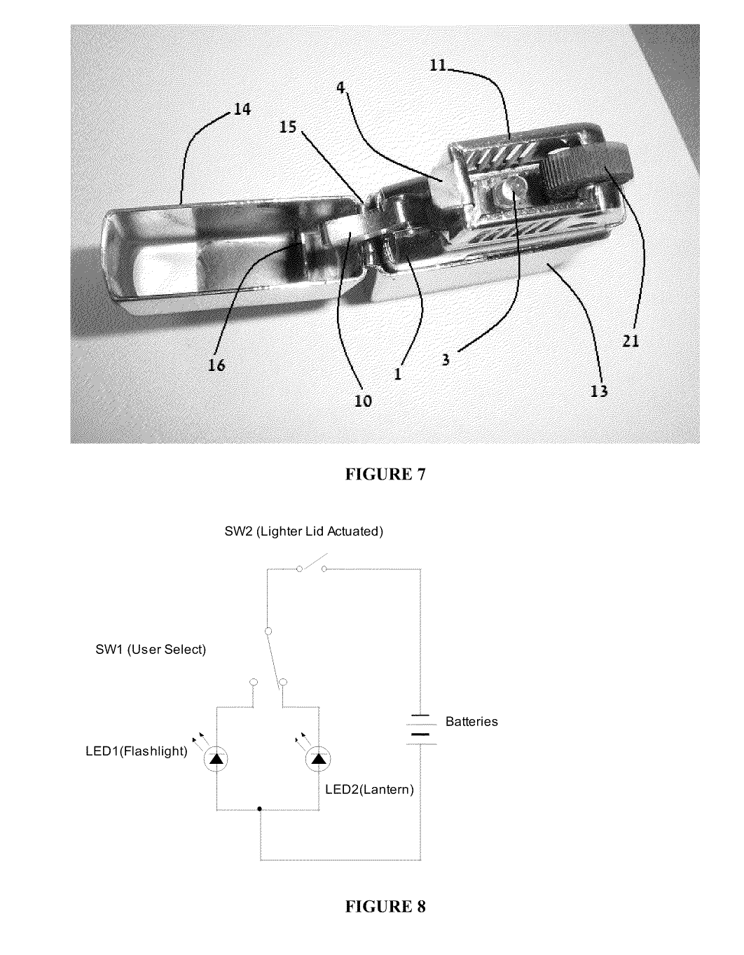

FIG. 7 is a top view of an oil-type cigarette lighter converted to a flashlight. The lid is open showing the various parts as already discussed. The outside case of the flashlight consists of the base 13 and lid 14. Inside lid 14 is cam plate 16. Typically, cam plate 16 is an integral part of the hinge 15 and works with cam 10 to snap the lid 14 closed. In this invention cam plate 16 is also used to activate electrical contact switch 4 when the lid 14 is closed on the base 13. The cam plate 16 surface opposite the surface used by the cam 10 is utilized to activate electrical contact switch 4 upon closure of lid 14. Electrical insulation must be provided between the surface of cam plate 16 and electrical contact switch 4 to prevent turning on LED 3 when the lid 14 is closed. This insulation can be on the outside tip of electrical contact switch 4 or can be located on the surface of cam plate 16 (i.e., by tape).

To prepare a standard oil-type cigarette lighter for conversion to a flashlight, the wick, and the lighter fluid absorbent (cotton) must be removed. In addition, depending on the design, the spark wheel and the flint tube may be removed. Generally, Lithium coin cells are used in the conversion. Usually, two CR2032 cells are used in smaller lighters and two CR2450 cells are used in larger lighters.

A latitude of modification, change and substitution is intended in the foregoing disclosure and in some instances some features of the invention will be employed without a corresponding use of other features. Accordingly, it is appropriate that the appended claims be construed broadly and in a matter consistent with the scope of this invention.

What is claimed is:

1. A flashlight comprising:
a modified oil-type cigarette lighter insert sub-assembly having an electrically insulated battery case located inside the said lighter insert subassembly; at least one insulated wire having one end electrically connected to an electrically conductive battery contact located within said battery holder, and the other end of said insulated wire electrically connected to a lamp module, where said lamp module is contained inside the wind guard of said lighter insert subassembly; and said insert sub-assembly is assembled into an outside case of an oil-type cigarette lighter.

2. The flashlight of claim 1, wherein said battery holder contains one or more batteries which have one battery terminal in electrical contact with said battery contact and the other terminal in electrical contact with said insert sub-assembly.

3. The flashlight of claim 1, wherein said lamp module contains one or more LEDs, each having one pin electrically connected to said insulated wire and the other pin electrically connected to a switch.

4. The flashlight of claim 3, wherein said switch is an electrical contact switch which makes electrical contact with said insert sub-assembly when the lid of the outside case is open causing said LEDs to turn on; and said electrical contact switch does not make electrical contact with said insert sub-assembly when the lid of the outside case is closed causing said LEDs to turn off.

5. The flashlight of claim 4, wherein said electrical contact switch makes electrically insulated contact with the hinge side of said lid of said outside case when said lid is closed, and said electrical contact switch does not make electrical insulated contact with said hinge side of said lid of said outside case when said lid is open.

6. The flashlight of claim 1, wherein said insulated wire passes through the wick hole in said insert sub-assembly

7. The flashlight of claim 4, wherein said electrical contact switch is replaced by a series combination of said electrical contact switch and a manually operated SPDT switch, whereby the SPDT switch is used to select one of two of said LEDs.

8. The flashlight of claim 7, wherein two of said LEDs may provide light output of the same color, different colors, or different beam characteristics.

9. The flashlight of claim 3, wherein said switch is an electronic circuit.

10. The flashlight of claim 9, wherein said electronic circuit is activated by a spark.

11. A flashlight sub-assembly comprising:
a modified oil-type cigarette lighter insert sub-assembly having an electrically insulated battery case located inside the said lighter insert subassembly; at least one insulated wire having one end electrically connected to an electrically conductive battery contact located within said battery holder, and the other end of said insulated wire electrically connected to a lamp module, where said lamp module is contained inside the wind guard of said lighter insert sub-assembly.

12. The flashlight sub-assembly of claim 11, wherein said battery holder contains one or more batteries which have one battery terminal in electrical contact with said battery contact and the other terminal in electrical contact with said insert sub-assembly.

13. The flashlight sub-assembly of claim 12, wherein said lamp module contains one or more LEDs, each having one pin electrically connected to said insulated wire and the other pin electrically connected to a switch.

14. The flashlight sub-assembly of claim 13, wherein said switch is an electrical contact switch which makes electrical contact with said insert sub-assembly when the lid of the outside case is open causing said LEDs to turn on; and said electrical contact switch does not make electrical contact with said insert sub-assembly when the lid of the outside case is closed causing said LEDs to turn off.

15. The flashlight sub-assembly of claim 14, wherein said electrical contact switch makes electrically insulated contact with the hinge side of said lid of said outside case when said lid is closed, and said electrical contact switch does not make electrical insulated contact with said hinge side of said lid of said outside case when said lid is open.

16. The flashlight sub-assembly of claim 11, wherein said insulated wire passes through the wick hole in said insert sub-assembly

17. The flashlight sub-assembly of claim 14, wherein said electrical contact switch is replaced by a series combination of said electrical contact switch and a manually operated SPDT switch, whereby the SPDT switch is used to select one of two of said LEDs.

18. The flashlight sub-assembly of claim 17, wherein two of said LEDs may provide light output of the same color, different colors, or different beam characteristics.

19. The flashlight sub-assembly of claim 13, wherein said switch is an electronic circuit.

20. The flashlight sub-assembly of claim 19, wherein said electronic circuit is activated by a spark.
